(19) United States
(12) Patent Application Publication
(10) Pub. No.: US 2008/0055621 A1
(43) Pub. Date: Mar. 6, 2008

(54) METHODS AND SYSTEMS FOR IMPROVED PRINTING SYSTEM SHEET SIDE DISPATCH IN A CLUSTERED PRINTER CONTROLLER

(76) Inventors: Suzanne L. Price, Longmont, CO (US); Vladimir V. Shestak, Fort Collins, CO (US); Howard Jay Siegel, Fort Collins, CO (US); James T. Smith, Boulder, CO (US); Prasanna V. Sugavanam, Newbury Park, CA (US); Larry D. Teklits, Loveland, CO (US)

Correspondence Address: DUFT BORNSEN & FISHMAN, LLP, 1526 SPRUCE STREET, SUITE 302, BOULDER, CO, 80302, US

(21) Appl. No.: 11/469,833

(22) Filed: Sep. 1, 2006

(51) Int. Cl. G06F 3/12

(52) U.S. Cl. 358/1.13

(57) ABSTRACT

Methods, systems, and apparatus for improved dispatching of sheetsides in a high-speed (e.g., continuous form) printing environment using multiple, clustered processors in a print controller. Features and aspects hereof generate, update, and utilize a mathematical model of multiple processors (compute nodes) each adapted to RIP (rasterize) raw sheetside data provided to it. A head node or control processor receives the raw sheetside files from an attached host or server, determines current processing capacity of each of the multiple compute nodes to RIP the next sheetside, and dispatches the sheetside to the compute node identified as providing the minimum RIP completion time. Various conditions may invalidate a compute node from further consideration in dispatch of a particular sheetside. Thus a valid compute node is selected based on the minimum RIP completion time.

### BACKGROUND

1. Field of the Invention

The invention relates to the field of printing systems and in particular relates to improved systems and methods for sheetside dispatch in high speed printing systems using a clustered computing printer controller.

2. Statement of the Problem

In high performance printing systems, which can be continuous form printing systems or cut sheet printing systems, the image marking engines apply RIPped (e.g., rasterized) images to continuous form paper moving through the marking engine at high rates of speed. Typically, pages to be imaged are combined into logical “sheetsides”, which consist of 1 or more pages of equal length which when laid out for printing, span the width of the print web. Bitmap images of each sheetside to be printed are generated (RIPped) by a printer controller coupled to the high speed printing engine. It is vital in such high performance printing systems that the printer controller generates required bitmaps rapidly enough to maintain continuous throughput of paper through the image marling engine.

Two undesirable situations can occur when sheetsides cannot be ripped fast enough to feed the printer at a specified speed:

1. The printer may slow its print speed as the quantity of ripped sheetsides ready to be printed decreases, thus causing a decrease in print throughput. This situation can happen in both continuous form and cut sheet printers.

2. In continuous form systems, the high speed marking engine may be forced to stop imprinting, stop the continuous form feed, and then restart at some later time when some predetermined quantity of ripped sheetsides is available for print. This type of event is known as a “backhitch”. Not only does backhitching cause reduced print throughput, it can also result in undesirable print quality or tearing of the print web due to the abrupt stoppage of the paper. If the print web is torn, even more time is consumed in recovering from such an event.

In higher volume printing system environments such as high volume transaction printing (e.g., consumer billing statements, payroll processing, government printing facilities, etc.) such wasted time in a slower than planned print speed or a backhitch operation can represent a substantial cost to the printing environment. Downtime in such high volume printing environments is a serious problem for which printing system manufactures expend significant engineering effort to resolve. These problems are further exacerbated in two sided or duplex printing operations where the continuous form paper is fed through a first image marking engine, physically turned over, and fed in a continuous form fashion through a second image marking engine for printing the opposing side of the medium. Stopping such printing systems and performing a backhitch operation to accurately position the paper in multiple image marking engines further complicates the problems. Further, the processing workload for the printer controller in generating bitmap images for duplex printing is approximately twice that of simplex or single sided printing processing.

It is generally known to provide additional computational processing power within the printer controller to help assure that required bitmaps will be ready in time for the image marking engine to avoid the need for time consuming stop and backhitch operations. One recently proposed improvement teaches the use of a cluster computing architecture for a printer controller wherein multiple computers/processors (“compute nodes”) are tightly coupled in a multiprocessor computing architecture. The aggregated computational processing power of the clustered computers provides sufficient processing capability in hopes of assuring that a next required bitmap image will always be available for the image marking engines.

Despite the presence of substantial computational power even in a clustered computing environment, there is a need to optimize the scheduling dispatch of sheetside bitmap image processing (“ripping”) on the multiple compute nodes in the cluster in order to produce an efficient and cost-effective system. Well-known simplistic scheduling algorithms fail to adequately ensure that a next required bitmap will likely be available when required by the marking engines. Use of such simplistic algorithms also typically results in the need to specify more compute nodes than would be necessary under most circumstances, resulting in a more expensive system.

It is evident from the above discussion that a need exists for an improved method and associated systems for scheduling dispatch of sheetside bitmap image processing (e.g., ripping) among the plurality of processors in a multi-computer clustered print controller environment to help reduce the possibility of image marking engine slowdown, or stoppage and backhitch.

### SUMMARY

The invention solves the above and other related problems with methods and associated systems and apparatus for improved sheetside dispatching in a printer environment employing a clustered, multi-processor printer controller.

In one aspect, a method is provided for distributing sheetside processing in a cluster computing printer controller. The method includes receiving a print job comprising multiple sheetsides. The method then performs steps for each received sheetside. The steps include determining an estimated RIP completion time for each sheetside for each processor of multiple processors in the printer controller. The steps also include dispatching each sheetside to a selected processor of the multiple processors having the minimum RIP completion time for each sheetside.

In another aspect, a method is provided for processing sheetsides in a cluster computing printer controller having multiple processors coupled to a head node processor. The method includes receiving, at the head node, raw sheetside data to be RIPped to generate a corresponding plurality of RIPped sheetside images. For each raw sheetside, the method then performs a number of steps. The steps performed include determining performance information that estimates the current processing capacity of each processor for RIPping each raw sheetside to generate a RIPped sheetside. The steps then include selecting a processor of the multiple processors based on the performance information and dispatching each raw sheetside to the selected processor.

The invention may include other exemplary embodiments described below.

### DESCRIPTION OF THE DRAWINGS

The same reference number represents the same element on all drawings.

FIG. 1 is a block diagram of an exemplary system embodying features and aspects hereof to improve sheetside dispatch in a multi-processor print controller.

FIG. 2 is a block diagram showing exemplary buffer and queue structures used in communication among the exemplary components of FIG. 1 in accordance with features and aspects hereof.

FIG. 3 is a block diagram showing an exemplary compute node processor of FIG. 1 with exemplary raw and RIPped sheetsides in its input and output queue structures.

FIG. 4 is a timing diagram showing an exemplary compliment of sheetsides and the estimated/actual start times and completion times for each of the exemplary sheetsides.

FIG. 5 is a flowchart broadly describing an exemplary method in accordance with features and aspects hereof to improve dispatch of sheetsides in a multi-processor clustered printer controller.

FIG. 6 is a flowchart describing another exemplary method in accordance with features and aspects hereof to improve dispatch of sheetsides in a multi-processor clustered printer controller.

FIG. 7 is a flowchart describing another exemplary method in accordance with features and aspects hereof to improve dispatch of sheetsides in a multi-processor clustered printer controller.

FIG. 8 is a timing diagram exemplifying a non-zero paper offset and its impact on sheetside dispatch.

FIG. 9 is a block diagram showing exemplary extensions of the system of FIG. 1 to enable color printing in accordance with the sheetside dispatch features and aspects hereof.

FIGS. 10 and 11 together show timelines regarding communication conflicts in a color extension to the system as in FIG. 9 and resolution of the conflicts in accordance with features and aspects hereof.

### DETAILED DESCRIPTION OF THE DRAWINGS

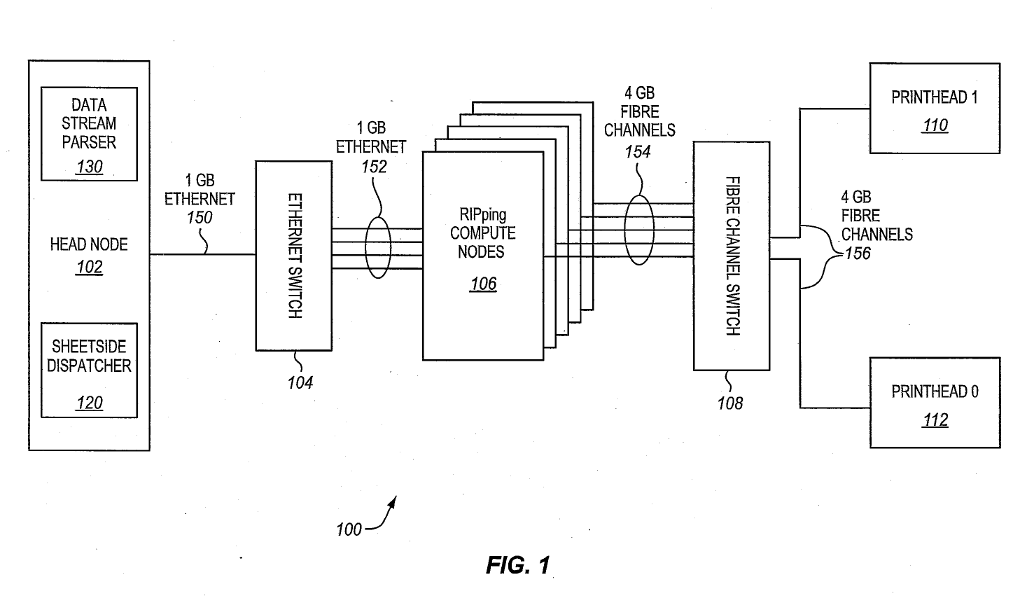

FIGS. 1 through 11 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of an exemplary system 100 configured, and adapted for operation in accordance with features and aspects hereof. System 100 may include three major components: head node 102, compute nodes 106, and printheads 110 and 112. Head node 102 may be any suitable computing device adapted to couple to attached host systems or print servers (not shown) and adapted to receive data representing raw pages. This data is raw in the sense that it is encoded in a form other than a RIPped bit map image of the desired sheetside. Rather, the raw data may be encoded in any of several well known page description languages such as PCL, Postscript, IPDS, etc. The components may be interconnected as shown in FIG. 1 such that the head node 102 is coupled through a switched fabric 104 to the plurality of compute nodes 106. The switched fabric may be, for example, Ethernet, Fibre Channel, etc. Each of compute nodes 106 may be a suitable computing device adapted to receive a raw sheetside from the head node and adapted to RIP (rasterize) the received sheetside to generate a corresponding RIPped sheetside (i.e., a rasterized bitmap version) corresponding to the sheetside described by the corresponding received raw sheetside data. Multiple such compute nodes 106 form a cluster.

As is known in the art, each compute node 106 as well as the head node 102 may be a general purpose or specialized computing device (including one or more processors). Thus, as used herein, the head node and each of the compute nodes may also simply be referred to as “computers”, “processors”, or “nodes”. The specific packaging and integration of the computers as one or more printed circuits, in a single enclosure or multiple enclosures, and the particular means of coupling the various computers are well known matters of design choice.

Head Node

Attached host systems and/or print server devices (not shown in FIG. 1) may stream print job input data to the head node 102 of system 100 through a high speed communication channel (not shown) such as a 10 Gb Ethernet channel. For purposes of model computations exemplified below, such a high speed channel may be presumed to provide approximately 50% payload efficiency in its data transmission. Files arriving at the head node 102 contain raw page descriptions—such as Postscript, Adobe PDF, HP PCL, or IBM IPDS/AFP. For purposes of this description it is also assumed that page descriptions arrive in the ascending order of page numbers and are stored at the head node in available space of an input queue Head node 102 may include a main functional element, datastream parser 130, which will take the input stream and parse the data into logical sheetside description files in order to provide discrete units of work to be RIPped. These logical sheetside description files may then be placed in yet another queue (e.g., for example a 4 GB buffer of RAM memory on the head node 102 may serve as such an input queue (“HNIQ”)).

Head node 102 may include a main functional element, sheetside dispatcher 120 (“SSD”). SSD 120 retrieves sheetside description files and distributes or dispatches them across the compute nodes 106 by executing a certain mapping (i.e., resource management) heuristic discussed further herein below. It is assumed that the estimated time required to produce a bitmap out of each sheetside description file (e.g., the RIP time) is known for each of the sheetsides. Those of ordinary skill in the art would readily recognize well known heuristics to estimate the RIP time for each sheetside description file. These estimates, among other dynamic factors discussed further herein below, may then be used by the mapping heuristic to make decisions about which sheetside to send to which compute node. The RIP time estimates are only estimates of RIP times and thus may differ from the actual RIP times.

For modeling of the operation of system 100 by the mapping heuristics, it may be assumed that all compute nodes provide the same computational power, i.e., it is a homogeneous system. Features and aspects hereof for modeling the system 100 can readily be extended for the case where compute nodes can differ in performance, i.e., a heterogeneous system. In the heterogeneous case, there must be a mechanism for estimating the RIP time of each sheetside on each type of compute node.

Compute Nodes

Compute nodes 106 can be represented as a homogeneous collection of “B” independent compute nodes (e.g., “compute nodes”, “processors”, “computers”, “nodes”, etc.). The main relevant use of each compute node is to convert sheetside description files received from the head node 102 to corresponding bitmap files. Sheet side description files assigned to a compute node 106 dynamically arrive from the head node 102 to an input queue associated with each compute node (e.g., a compute node input queue or “BIQ”). Each compute node 106 also has an output queue for storing completed, RIPped sheetsides (“BOQ”). The compute node retrieves the sheetside files in its input queue in FIFO order for rasterization as soon as the compute node's output buffer has enough space to accommodate a complete generated bitmap. The total amount of buffer memory in each compute node is divided between the compute node's input and output buffers at system initialization time. The sizes of the bitmaps generated are known to be constant as a function of the bitmap resolution and size to be generated.

For the exemplary model and dispatch heuristics discussed herein below, it may be assumed that no bitmap compression will be used. Features and aspects hereof can readily be extended to handle compression for the case where the RIP times are extended to include time for performing compression. Further, the model and heuristics may be easily extended to account for variability in the size of generated bitmaps due to compression. Such extensions are readily apparent to those of ordinary skill in the art.

Before a sheetside can be RIPped there must be space in the compute node output buffer sufficient to accommodate the uncompressed bitmap. Using compression the size of the compressed bitmap is unknown until compression completes. Therefore, even utilizing compression, where the final compressed bitmap size may be less than the uncompressed bitmap, size sufficient space must be reserved to accommodate the entire uncompressed bitmap. After the sheetside is RIPped, the actual compressed bitmap size will be known and can be used to determine what space remains available in the given compute node's output buffer.

Two control event messages may be originated at the compute node 106 for use in the model and heuristics discussed further herein below. An event message may be generated indicating when rasterization for a given sheetside is completed. One control event message is sent to the head node 102 carrying the sheetside number of the bitmap, its size, and its creation time. Another control message is forwarded to the corresponding printhead (110 or 112) indicating that the bitmap for the given sheetside number as now available on the compute node 106.

Printheads

Two identical printheads may be employed in a monochrome, duplex print capable embodiment of features and aspects hereof. A first printhead 110 is responsible for printing odd numbered sheetsides, while printhead 112 is responsible for printing even numbered sheetsides. Sheet sides are printed in order according to sheetside numbers. For purposes of the model and heuristics discussed herein below, printing speed is presumed constant and known. A typical printhead interface card has sufficient memory to store some fixed number of RIPped bitmaps or a fraction thereof. In the discussion below, an exemplary buffer size associated with the printheads may be presumed to be equal to two (2) uncompressed bitmaps. Persons skilled in the art will readily see how the data transfer method could be modified to handle a buffer which is less than 2 bitmaps in size.

Bitmaps are requested sequentially by the printheads 110 and 112 from the compute nodes 106 based on information about which bitmaps are in each compute node's output buffer. This information is acquired by the printheads upon receiving control messages from the compute nodes as noted above. When the printhead interface card's buffer memory is full, the next bitmap will be requested from the compute node at the time when the printhead completes printing one of the stored bitmaps.

In this exemplary two printhead monochrome system, printhead 0 112 will print the even numbered sheetsides, and printhead 1 110 will print the odd numbered sheetsides. The sheetsides will be printed on both sides of a sheet of paper of the continuous form paper medium. For simplicity of this discussion, it may be presumed that the print job begins with sheetside 1 printed on printhead 1, and printhead 0 must print sheetside 2 on the other side of the sheet, at some time later. The time difference between when sheetside 1 and sheetside 2 are printed depends on the physical distance between the two printheads, the speed at which the paper moves, etc. This time difference defines the order in which sheetsides are needed by the printheads, e.g., the time when sheetside 15 is needed by printhead 1 may be the same time that sheetside 8 is needed by printhead 0 (in this example an offset of 15−8=7 will be a constant offset between odd and even numbered sheetsides that are needed simultaneously). Without loss of generality, this discussion will assume an offset of 0. This assumption will simplify the description in this document. The incorporation of offsets greater than 0 is discussed further herein below.

Communication Links

As shown in exemplary system 100 of FIG. 1 there may be a 1 GB Ethernet network (150 and 152 of FIG. 1) connecting the head node 102 and the compute nodes 106 with one crossbar Ethernet switch 104 between them. This network serves to transfer sheetside description files from the head node 102 to any of the compute nodes 106. Assuming a typical 50% payload efficiency of the Ethernet, 500 MB/sec would be a typical effective communication bandwidth to model the channel from the head node 102 to the compute nodes 106 for this exemplary system 100.

There may be a 4 GB Fibre Channel network (154 and 156 of FIG. 1) connecting the compute nodes 106 and the printheads 110 and 112 with one crossbar switch 108 between them. This network is used to transfer bitmaps from any compute node 106 to any printhead 110 or 112.

Those of ordinary skill in the art will readily recognize that these exemplary communication channel types and speeds may vary in accordance with the performance requirements and even the particular data of a particular application. Thus, system 100 of FIG. 1 is merely intended as exemplary of one typical system in which features and aspects hereof represented by SSD 120 may be advantageously employed.

Mathematical Model

In general the dispatch mapping heuristics in accordance with features and aspects hereof help assure that each bitmap (RIPped sheetside) required by each printhead will be available when needed by the printhead. In achieving this goal, features and aspects hereof account for the following issues in modeling operation of the system:
1. As noted above, the estimated time to RIP a bitmap is known to the SSD for each sheetside. Due to the fact that these estimates are only approximations, the mapping has to be made under uncertainty and thus should defer the dispatch to the last possible time.
2. Sheet sides must print in order according to sheetside number.
3. The compute nodes' input and output buffers are constrained in size. Hence, there is a limit on the number of sheetsides that can be buffered at any point in time.
4. An arrival process of the new sheetside description files proceeds in parallel with printing. This implies that the mapping has to be produced dynamically as conditions of the system may change dynamically.

In accordance with features and aspects hereof, assignments to compute nodes are made by the SSD for individual sheetsides sequentially in order of sheetside numbers. In one aspect, the SSD distributes sheetsides across the compute nodes based on the principle that a sheetside is mapped to the compute node that minimizes the estimated RIP completion time for that sheetside. In other words, each sheetside is assigned to its Minimum RIP Completion Time (MRCT) compute node. A mathematical model for estimating the completion time of a sheetside is presented herein below. The mathematical model forms the basis for the heuristic mapping methods and structures operable in accordance with features and aspects hereof.

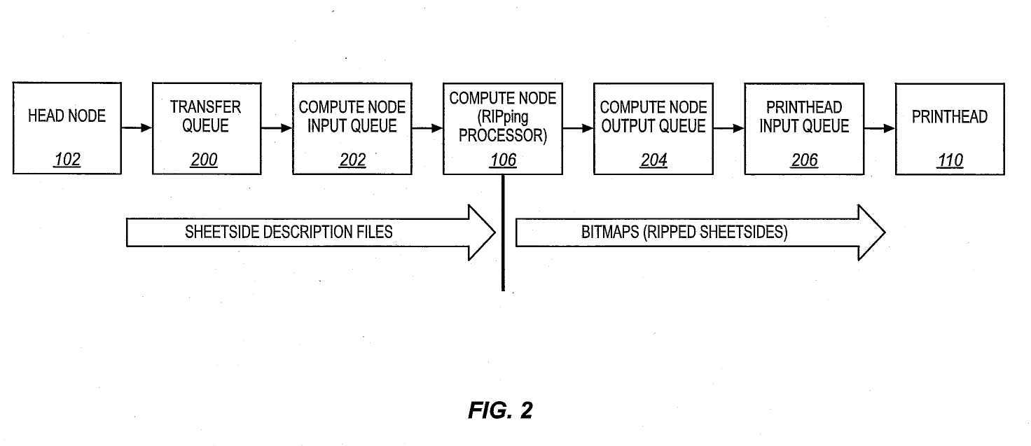

The mathematical model discussed herein below presumes an exemplary queuing structure in the communications between the various components. Some constraints and parameters of the model depend on aspects of these queues and the communication time and latencies associated therewith. FIG. 2 shows the data flow in the system of FIG. 1 with the head node 102, a single compute node 106, and a single printhead 110 with the various exemplary queues associated with each. In particular, transfer queue 200 receives sheetside descriptions from head node 102 to be forwarded to the input queue 202 of a selected compute node processor 106. Compute node input queue 202 may be constrained only by its total storage capacity and thus may store any number of sheetside descriptions forwarded to it constrained only by its maximum storage capacity. By contrast, transfer queue 200 may be limited to a predetermined number of sheets sides regardless of its storage capacity. More specifically, in an exemplary preferred embodiment, transfer queue 200 has capacity to store only two sheetside descriptions. This constraint helps assure that the sheetside dispatching algorithms, in accordance with features and aspects hereof, defer selecting a particular compute node processor for a particular sheetside as late as possible. This imposed delay allows the dynamic nature of the system to change such that a better compute node may be selected by the heuristics.

Compute node processor 106 eventually processes and then subsequently dequeues each sheetside description from its input queue 202 (in FIFO order to retain proper sequencing of sheetsides). Each sheetside description is dequeued by the compute node 106 from its input queue 202, processed to generate a corresponding bitmap or RIPped sheetside, and the resulting RIPped sheetside is stored in the compute node output queue 204 associated with this selected compute node 106. As above with respect to input queue 202, the output queue 204 of compute node 106 is constrained only by its total storage capacity. Where bitmaps are uncompressed and hence all equal fixed size the number of bitmaps that may be stored in output queue 204 is also fixed. Where bitmap compression is employed, the maximum number of bitmaps in the output queue 204 may vary.

Eventually, printhead 110 will determine that another bitmap may be received in its input queue 206 and requests the next expected RIPped sheetside from the appropriate output queue for the compute node 106 that generated the next sheetside (in sheetside number order). As noted above, the buffer space associated with printhead 110 is typically sufficient to store two sheets such that the first sheet is in process scanning on the printhead while a second RIPped sheetside is loaded into the buffer memory. Such “double-buffering” is well known to those of ordinary skill in the art.

The mathematical model discussed further herein below presumes the following:
1. RIP completion time estimates for sheetsides may deviate from actual RIP completion times.
2. When a sheetside has been assigned to a compute node, after it leaves the head node, it cannot be reassigned to another compute node. More precisely, sheetsides cannot be reassigned after they are placed in the transfer queue of the head node.
3. The time required to execute the mapping heuristic may be neglected.
4. The system is considered to be in a steady state of operation implying that the time that the first bitmap was needed by any printhead is known The “startup” state is not considered herein.
5. The time required for the print engine to print a bitmap is constant.
6. The bitmap size is fixed for all sheetsides.
7. There is exactly one print job consisting of C sheetsides, where the actual sheetside numbers of the print job are numbered 1 to σ. Those of ordinary skill in the art will readily recognize extensions to the model to accommodate multiple consecutive jobs.
8. During rasterization (ripping) of a sheetside on a compute node, the description file of the sheetside will remain in the input buffer of the compute node (for purposes of computing queue utilization), and space sufficient for the entire resultant bitmap will be reserved in the output buffer of the compute node (for purposes of computing queue utilization).

Mathematical Model—Sheet Side Deadline

As regards the start times of the printheads, let t₀ be the start time of printhead 0 (e.g., printhead 112 of FIG. 1) and t₁ be the start time of printhead 1 (e.g., printhead 110 of FIGS. 1 and 2). Note that t₀ and t₁ may be absolute wall-clock times. From the printhead start times, each printhead requires a new bitmap every tₚᵣᵢₙₜ seconds, where tₚᵣᵢₙₜ is the time to print a bitmap on the printhead. Let printhead 1 start printing first and let x be the number of sheetsides (all of which will be odd numbered) printed by printhead 1 before starting print engine 0. Then, t₀ can be given in terms of t₁ as t₀=t₁+tₚᵣᵢₙₜ×x. Given the i^{th} “actual sheetside number” of the print job denoted SSᵢ, and numbered from 1, the SSᵢ bitmap has to be available for printing at time

$${t}_{1} + {t}_{print} \times ( \frac{{SS}_{i} - 1}{2} )$$

if i is odd, and at time

$${t}_{0} + {t}_{print} \times ( \frac{{SS}_{i}}{2} )$$

if i is even. Let tₜᵣₐₙ^{bitmap} be the bitmap transfer time from the compute nodes to a printhead. Then, SSᵢ's deadline, t_{d}[SSᵢ], indicates the latest wall-clock time for a compute node to produce SSᵢ's bitmap:

$${t}_{d} [ {SS}_{i} ] = \{ \begin{matrix} {t}_{1} + {t}_{print} \times ( \frac{{SS}_{i} - 1}{2} ) - {t}_{tran}^{bitmap} & if {SS}_{i} is odd \\ {t}_{0} + {t}_{print} \times ( \frac{{SS}_{i}}{2} ) - {t}_{tran}^{bitmap} & if {SS}_{i} is even\end{matrix} \qquad ( 1 )$$

The deadline calculation will be used to determine the time delay to begin processing a sheetside on a compute node. For this purpose, the deadline equation needs to be expressed in terms of the ordering of sheetsides on a given compute node. Let BQᵢ^{j} be the i^{th} sheetside to have entered compute node j's input queue for a given job. Define the operator num[BQᵢ^{j}] that evaluates to the actual sheetside number. Then, (1) can be rewritten as follows:

$${t}_{d} [ {BQ}_{i}^{j} ] = \{ \begin{matrix}{t}_{1} + {t}_{print} \times ( \frac{num [ {BQ}_{i}^{j} ] - 1}{2} ) - {t}_{tran}^{bitmap} & if num [ {BQ}_{i}^{j} ] is odd \\ {t}_{0} + {t}_{print} \times ( \frac{num [ {BQ}_{i}^{j} ]}{2} ) - {t}_{tran}^{bitmap} & f num [ {BQ}_{i}^{j} ] is even\end{matrix} \qquad ( 2 )$$

Mathematical Model—Estimated Departure Time

Let HNᵢ be the i^{th} sheetside to enter the head node input queue (HNIQ) for a given print job. HNᵢ is the same as SSᵢ when 0 paper offset is assumed between the printheads responsible for printing odd and even sheetsides. The case when the paper offset is non-zero is discussed further herein below. Let HNᵢ₋₁ be the sheetside ahead of HNᵢ in the head node input queue. To evaluate estimated departure time for HNᵢ to compute node j, the input buffer capacity of compute node j must be considered. The space in the compute node input buffer is limited by the two factors: the maximum number of sheetside description files (Q) allowed by the mapping algorithm, and the total number of bytes of memory allocated to the input buffer. The calculation of the estimated RIP completion time of HNᵢ on compute node j includes summing the estimated times to RIP the sheetsides assigned to that compute node but not RIPped yet. The result of this calculation is subject to the estimation error accumulated, which may increase as the number of sheetsides in a compute node input queue increases. The first factor helps to reduce this accumulated error. If the size of sheetside HNᵢ is less than or equal to the available input buffer capacity of compute node j, then HNᵢ can be immediately sent to the input buffer of compute node j following the transfer of HNᵢ₋₁. Otherwise, HNᵢ will be delayed at the head node for the amount of time needed for a certain number of sheetsides previously assigned to compute node j to be rasterized, to create input buffer capacity sufficient to accommodate HNᵢ.

Let the estimated RIP completion time of HNᵢ on compute node j be t_{comp}^{j}[HNᵢ]. To calculate the available input buffer capacity at compute node j, form the sequence J of all sheetsides mapped to compute node j. Sheet sides in sequence J are ordered as they were mapped to compute node j, i.e., in the older first order. Let sequence K be formed of elements of J that have not yet been RIPped at the time when the transmitter at the head node is ready to start transmitting HNᵢ to the compute nodes. The transmitter becomes ready for HNᵢ when it is finished with HNᵢ₋₁. Let t_{dept}^{x}[HNᵢ₋₁] be the departure time of HNᵢ₋₁ to its minimum completion time compute node x, and let tₜᵣₐₙ^{xdf}[HNᵢ₋₁] be the time required to transfer HNᵢ₋₁'s sheetside description file to the selected compute node. Mathematically, sequence K is defined for HNᵢ by the following equation:

K={HNₖεJ: t_{comp}^{j}[HNₖ]>t_{dept}^{x}[HNᵢ₋₁]+tₜᵣₐₙ^{xdf}[HNᵢ₋₁]}

Let the operator size[HNₖ] give the size of the HNₖ sheetside description file and let CAPᵢₙ^{j} be the total input buffer byte capacity of compute node j, both in bytes. Then, the available capacity in the input buffer of compute node j, AC_{inf}, is given by,

$$A {C}_{inj} = {CAP}_{i n}^{j} - {\sum }_{∀ {HN}_{k} ∈ K} size [ {HN}_{k} ]$$

If size[HNᵢ]≦AC_{inf} and |K|<Q, HNᵢ can depart at time

t_{dept}^{j}[HNᵢ]=t_{dept}^{x}[HNᵢ₋₁]+tₜᵣₐₙ^{xdf}[HNᵢ₋₁].

Otherwise, HNᵢ must wait until enough sheetsides have been processed from the input buffer of compute node j, so that these two conditions hold. If after the processing of some BQₘ^{j}εK these conditions hold, then t_{dept}^{j}[HNᵢ]=t_{comp}^{j}[BQₘ^{j}]. The exemplary pseudo code below suggests an exemplary approach for finding the estimated departure time for sheetside HNᵢ if assigned to compute node j, denoted t_{dept}^{j}[HNᵢ]. If i=1, i.e., HNᵢ is the first sheetside to be assigned by the SSD, HNᵢ can depart immediately.

```
if (size[HNᵢ] ≦ ACᵢₙⱼ & |K| < Q)
    t_{dept}^{j}[HNᵢ] = t_{dept}^{x}[HNᵢ₋₁] + tₜᵣₐₙ^{sdf}[HNᵢ₋₁];
else
{
    min_size = ACᵢₙⱼ;
    files = |K|;
    iter = first element in sequence K;
    while (size[HNᵢ] > min_size or files ≧ Q)
    {
        min_size = min_size + size[BQᵢₜₑᵣ^{j}];
        iter = iter+1;
        files=files−1;
    }
    t_{dept}^{j}[HNᵢ] = t_{comp} [BQᵢₜₑᵣ₋₁^{j}];
}
```

Mathematical Model—Delay before Processing

Let the RIP completion time of BQᵢ^{j} on compute node j be t_{comp}[BQᵢ^{j}]. If BQᵢ^{j} has been RIPped then t_{comp}[BQᵢ^{j}] is actual, otherwise it is estimated. Consider compute node j with output buffer capacity CAPₒᵤₜ^{j} measured in bytes. Because bitmaps are all assumed to be the same size (unless the method is adapted to permit bitmap compression), the number of bitmaps that could be placed in the output buffer of any compute node is constant. Assume N bitmaps can be placed in the compute node's output buffer. Define the delay to begin processing sheetside BQᵢ^{j}, Δₒᵤₜ[BQᵢ^{j}], as a waiting period from the time when BQᵢ^{j} reaches the head of compute node's input buffer to the time when the compute node's processor is ready to retrieve it for rasterization. If BQᵢ^{j} is at the head of compute node j's input buffer, BQᵢ₋₁^{j} must have completed processing. To determine Δₒᵤₜ[BQᵢ^{j}], three cases are considered:
Case 1: The output buffer of compute node j is not full because fewer than N sheetsides have entered compute node j's input queue. Therefore, Δₒᵤₜ[BQᵢ^{j}] is zero.
Case 2: More than N sheetsides have entered compute node j's input queue, but at the time when sheetside BQᵢ₋₁^{j} completes there will be at least one open bitmap slot in the output buffer, i.e., at least BQ_{i-N}^{j} sheetsides have left the output buffer. Therefore, Δₒᵤₜ[BQᵢ^{j}] is zero.
Case 3: The output buffer of compute node j is full when sheetside BQᵢ₋₁^{j} completes, and therefore, BQᵢ^{j} must wait for an opening in the output buffer before its processing can begin. Sheet side BQᵢ^{j} will be delayed until the sheetside at the head of the output buffer is completely transmitted to a printhead.

Mathematically, the delay for BQᵢ^{j} to begin processing is given by:

$${Δ}_{out} [ {BQ}_{i}^{j} ] = \{ \begin{matrix} 0 & if i < N & ( Case 1 ) \\ 0 & if {t}_{d} [ {BQ}_{i - N}^{j} ] + {t}_{tran}^{bitmap} \leq {t}_{comp} [ {BQ}_{i - 1}^{j} ] & ( Case 2 ) \\ {t}_{d} [ {BQ}_{i - N}^{j} ] + {t}_{tran}^{bitmap} - {t}_{comp} [ {BQ}_{i - 1}^{j} ] , & otherwise & ( Case 3 )\end{matrix}$$

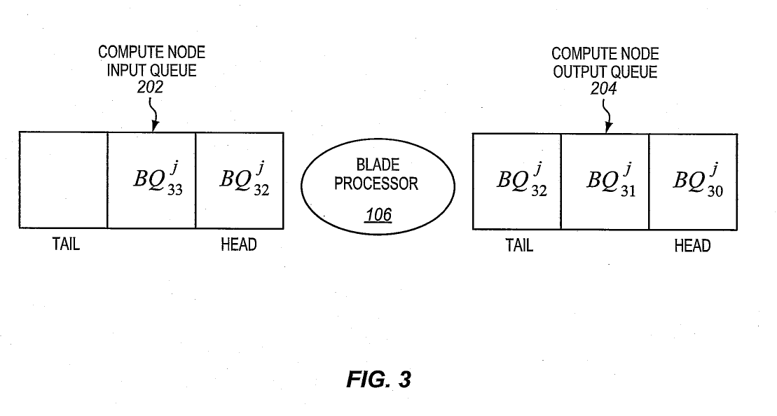

An example calculation of sheetside delay Δₒᵤₜ[BQᵢ^{j}], is presented in FIG. 3 below. Let N=3, and i=33 (recall 33 is the compute node j index and not the actual sheetside number). Consider compute node j in the state when sheetside BQ₃₂^{j} is being RIPped.

Evaluating the three cases for Δₒᵤₜ[BQ₃₃^{j}] reveals that Case 1 does not apply because i is greater than N. The other two cases apply as follows (Case 2 applies when BQ₃₀^{j} is not in the output buffer in FIG. 3).

$${Δ}_{out} [ {BQ}_{33}^{j} ] = \{ \begin{matrix} 0 & if {t}_{d} [ {BQ}_{30}^{j} ] + {t}_{tran}^{bitmap} \leq {t}_{comp} [ {BQ}_{32}^{j} ] & ( case 2 ) \\ {t}_{d} [ {BQ}_{30}^{j} ] + {t}_{tran}^{bitmap} - {t}_{comp} [ {BQ}_{32}^{j} ] & otherwise & ( case 3 )\end{matrix}$$

Mathematical Model—Estimated RIP Completion Time

The estimated RIP start time of sheetside BQᵢ^{j}, denoted tₛₜₐᵣₜ[BQᵢ^{j}], occurs when two conditions are satisfied: BQᵢ^{j} is present at the head of the input buffer of compute node j, and compute node j's output buffer has space sufficient to accommodate it. If these conditions are not satisfied then tₛₜₐᵣₜ[BQᵢ^{j}] will be defined as follows:
If there is no opening in the output buffer of compute node j when BQᵢ₋₁^{j} completes and BQᵢ^{j} is available at the head of the input buffer of compute node j. The estimated RIP start time of BQᵢ^{j} is equal to the sum of the estimated RIP completion time of BQᵢ₋₁^{j} and Δₒᵤₜ[BQᵢ^{j}].
If there is an opening at the output buffer of compute node j when BQᵢ₋₁^{j} completes and BQᵢ^{j} is not in the input buffer of compute node j, then the estimated start time of BQᵢ^{j} is equal to the arrival time of BQᵢ^{j} in the input buffer (departure time from the head node plus the transfer time of BQᵢ^{j}). As soon as BQᵢ^{j} arrives in the input buffer, it will be RIPped without any further delay.
If there is no opening in the output buffer on compute node j and BQᵢ^{j} is not in the input buffer of compute node j then one of the previous two cases will occur some time in the future.

Let the estimated RIP execution time, ERET[BQᵢ^{j}], be the estimated time required to rasterize sheetside BQᵢ^{j}. Then, t_{comp}[BQᵢ^{j}] can be calculated by adding the ERET[BQᵢ^{j}] to the start time for BQᵢ^{j}:

t_{comp}[BQᵢ^{j}]=tₛₜₐᵣₜ[BQᵢ^{j}]+ERET[BQᵢ^{j}]

Let t_{dept}[BQᵢ^{j}] be the estimated departure time for sheetside BQᵢ^{j} to compute node j (as discussed above for t_{dept}^{j}[HNᵢ]), and let tₜᵣₐₙ^{xdf}[BQᵢ^{j}] be the time required to transfer BQᵢ^{j}'s sheetside description file to the selected compute node. Then, tₛₜₐᵣₜ[BQᵢ^{j}] can be calculated using the following equation:

tₛₜₐᵣₜ[BQᵢ^{j}]=max {(t_{comp}[BQᵢ₋₁^{j}]+Δₒᵤₜ[BQᵢ^{j}]),(t_{dept}[BQᵢ^{j}]+tₜᵣₐₙ^{xdf}[BQᵢ^{j}])}

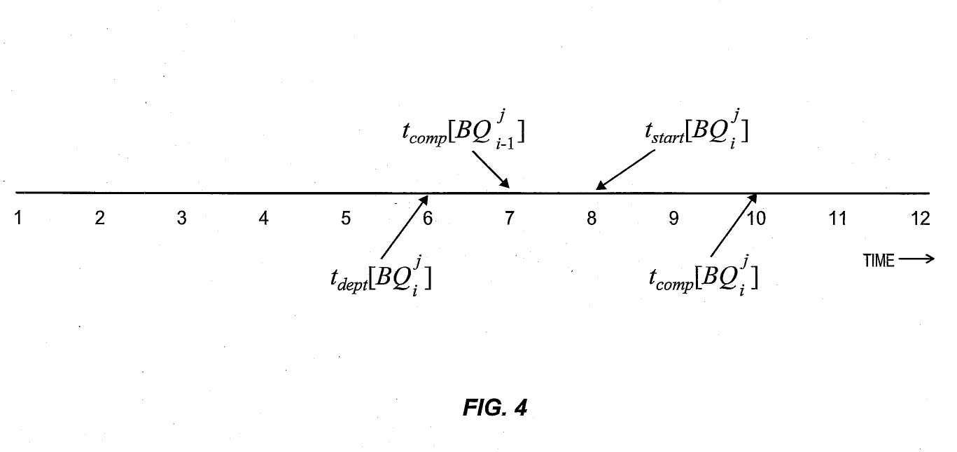

An example calculation for t_{comp}[BQᵢ^{j}] is shown in FIG. 4 where: ERET[BQᵢ^{j}]=2; t_{comp}[BQᵢ₋₁^{j}=7; Δₒᵤₜ[BQᵢ^{j}]=1; t_{dept}[BQᵢ^{j}]=6; and tₜᵣₐₙ^{xdf}[BQᵢ^{j}]=0.1.

### The estimated completion time for BQ is given by,

t_{comp}[BQᵢ^{j}]=max{(7+1), (6+0.1)}+2=8+2=10.

Note that calculation of t_{comp}[BQᵢ^{j}] is based on recursion because it depends on tₛₜₐᵣₜ[BQᵢ^{j}], which in turn depends on t_{comp}[BQᵢ₋₁^{j}]. The recursion basis is formed with BQ₁^{j}, whose t_{comp}[BQ₁^{j}] is found as follows:

t_{comp}[BQ₁^{j}]=ERET[BQ₁^{j}]+t_{dept}[BQ₁^{j}]+tₜᵣₐₙ^{xdf}[BQ₁^{j]}

Mathematical Model—Summary

Summarizing the mathematical model, for any sheetside BQᵢ^{j}, its RIP completion time estimate can be computed based on:
1. The RIP completion time of its predecessor on this compute node t_{comp}[BQᵢ₋₁^{j}]: The RIP completion time for the predecessor of BQᵢ^{j} is either estimated or actual, depending on whether BQᵢ₋₁^{j} has been RIPped at the time when sheetside BQᵢ^{j} is considered for mapping.
2. ERET[BQᵢ^{j}]: Known estimated value.
3. t_{dept}BQᵢ^{j}]: Calculated as explained above for t_{dept}^{j}[HNᵢ].
4. Δₒᵤₜ[BQᵢ^{j}] Calculated as explained above.
5. tₜᵣₐₙ^{xdf}[BQᵢ^{j}]: Known value.

Head Node Model and Mapping Heuristic—Overview

The mapping heuristic described in this section assumes the system is in a steady state, i.e., some sheetsides have already been RIPped and the printhead start times t₀ and t₁ are known. A mapping of a sheetside is made to the MRCT compute node, which is found based on the mathematical model described above. Upon feedback that a compute node has completed a bitmap, the RIP completion time estimates of the sheetsides assigned but not completed at this compute node are recalculated. The sheetside at the head of the head node input queue is placed in the transfer queue to be sent to its MRCT compute node when the compute node has enough room in the input buffer to accommodate that sheetside.

The transfer queue (TQ) as discussed above is a queue on the head node that is used to pass sheetsides to a transmitter for transfer to the compute nodes from the head node. Once a sheetside is in the transfer queue, the mapping for that sheetside can no longer be changed. The transfer queue is limited to two sheetsides to postpone finalizing mapping decisions as long as possible. This allows the SSD to obtain the latest feedback information from the compute nodes to correct errors in the RIP completion time estimates. The earliest expected feedback time (EEFTⱼ) of a compute node j is defined as the time that the sheetside being currently rasterized on the compute node is expected to be completed.

When sheetsides arrive at the head node input queue from an attached host or server via the datastream parser, they are considered for assignment in the order of sheetside numbers. For example, sheetside 43 (HNᵢ) will be mapped to a compute node before sheetside 44 (HNᵢ₊₁) is considered. By mapping sheetsides in order, certain deadlock scenarios can be avoided. Deadlock may occur due to the finite output buffer capacity of individual compute nodes. When sheetsides that have a later deadline occupy the output buffer of a compute node, a sheetside with an earlier deadline might be stuck in the input buffer of the same compute node.

Due to errors in the estimated completion times, if an opening at the input buffer of any compute node (possibly on the MRCT compute node for HNᵢ₊₁) happens before there is an opening at the MRCT compute node of HNᵢ, the MRCT calculation for HNᵢ is performed again to check if HNᵢ could be sent to the compute node that produced the opening. However, if it turns out that the compute node having produced the opening is still not the MRCT compute node for HNᵢ, HNᵢ₊₁ is still not considered for the following reasons:
a) Sending HNᵢ₊₁ to its MRCT compute node ahead of HNᵢ could potentially block the opportunity of HNᵢ to go to that compute node. At some future time, another opening might occur on the same compute node causing it to be the MRCT compute node for HNᵢ (if HNᵢ₊₁ has not been assigned).
b) While transferring HNᵢ₊₁ to its MRCT compute node, an opening might occur on the MRCT compute node of HNᵢ or on any other compute node that may turn out to be HNᵢ's MRCT compute node. This leads to HNᵢ waiting for the amount of time it takes for the head node to compute node transmitter to become free.

Head Node Model and Mapping Heuristic—Procedure

For the sheetside considered, a compute node lookup table is first formed. Note that only one lookup table must be maintained at any given point in time. The lookup table contains the following information:
a) estimated RIP completion time of the sheetside on each compute node (t_{comp}^{j}[HNᵢ]),
b) earliest expected feedback time of each compute node (EEFTⱼ),
c) invalidation time (explained later),
d) currently available space in each compute node's input buffer (ACᵢₙⱼ),
e) status of each compute node (valid/invalid).

The entire table is sorted (ranked) in ascending order based on the estimated RIP completion time of the sheetside on the compute nodes and the table is dynamically updated upon receiving feedback from a compute node. A compute node j status is said to be invalid indicating that this compute node is no longer considered for mapping for a given sheetside when the following condition is satisfied:

current time>(EEFTⱼ+(t_{comp}^{k}[HNᵢ]−t_{comp}^{j}[HNᵢ])),

where k is the compute node next ranked in the table. The right hand side of the above equation is called the invalidation time (INVTⱼ). A compute node is said to be valid until its invalidation time is passed. If there is no other valid MRCT compute node in the sorted table after the current MRCT compute node j, then the INVTⱼ is the same as the EEFTⱼ.

TABLE 1
An example compute node lookup table for HNᵢ with
size(HNᵢ) = 40 MB at wall-clock time 35.

| rank | compute node # | t_{comp}^{j}[HNᵢ] | EEFTⱼ | INVTⱼ | ACᵢₙⱼ | status |
|---|---|---|---|---|---|---|
| 1 | 2 | 50 | 32 | 32 + (54 − 50) = 36 | 35 MB | valid |
| 2 | 0 | 54 | 38 | 38 + (57 − 54) = 41 | 60 MB | valid |
| 3 | 1 | 57 | 40 | 40 | 14 MB | valid |
| 4 | 3 | 53 | 28 | 28 + (54 − 53) = 29 | 25 MB | invalid |

The invalidation time INVTⱼ defines the maximum wall-clock time by which compute node j can be considered for HNᵢ mapping. As soon as the current time is equal to INVTⱼ, the estimated RIP completion time on compute node j becomes just as good as the estimated RIP completion time on the compute node ranked next in the table. However, that compute node must have all of the required conditions hold to be assigned the considered sheetside (i.e., space in the input buffer and be valid). Furthermore, the fact that the expected feedback has not arrived from compute node j since EEFTⱼ indicates that estimated t_{comp}^{j}[HNᵢ] will significantly deviate from its actual value. Therefore, it is reasonable to stop considering compute node j for the HNᵢ mapping. An example compute node lookup table is shown in Table 1.

Applying the Model Using Heuristic Rules

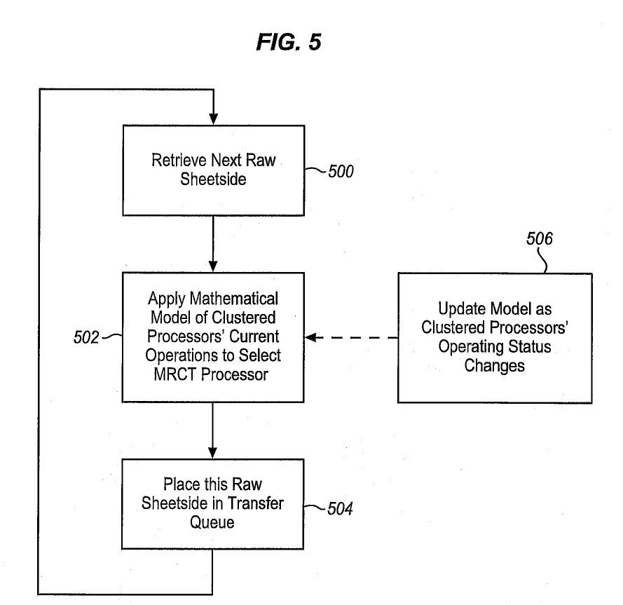

FIG. 5 is a flowchart broadly describing operations of the system in accordance with features and aspects hereof to utilize the above discussed mathematical model. The method of FIG. 5 applies heuristic rules based on the model selection of a preferred processor for ripping each received raw sheetside. The method of FIG. 5 is operable within the head node or any designated control processor of the system. In general such a control processor will be that which is coupled to attached host systems and/or servers and coupled to the plurality of compute nodes/processors. The control node is adapted to receive parsed print data (raw sheetsides) and possesses the computational power to select a preferred MRCT processor from among the compute nodes/processors. The control processor/head node then dispatches each raw sheetside to its MRCT processor.

Element 500 is first operable to retrieve the next raw sheetside from a buffer or queue associated with the head node. The head node input queue is used for storing all received raw sheetsides in sheetside order as received from the datastream parser. In general, all received raw sheetside data may be stored in a queue structure such that each raw sheetside comprises an identifiable group or file identified by the sheetside number. As noted above, for simplicity of this description, it may be presumed that the system operates on a single print job having multiple raw sheetsides numbered 1 through N. Simple extensions readily understood by those of ordinary skill in the art may adapt the method of FIG. 5 to process multiple jobs each having a distinct number of sheetsides associated therewith each commencing with a sheetside numbered 1 relative to that job.

Element 502 is operable to apply the mathematical model estimating the current operating parameters and processing capacity of each processor of the multiple processors/compute nodes. Element 502 applies heuristic rules based on the above discussed mathematical model to determine a minimum RIP completion time (MRCT) processor/compute node for processing/ripping this next raw sheetside. Element 504 is then operable to dispatch this raw sheetside to the selected MRCT processor to be RIPped and eventually forwarded to the printhead in proper order. Processing then loops back to element 500 to continue processing other raw sheetsides received at the head node.

Substantially concurrently with the operation of elements 500 through 504, element 506 is operable to continuously update the parameters used in the mathematical model describing current operating status and capacity of the plurality of processors/compute nodes. This present operating status changes as each raw sheetside is completely RIPped by its assigned processor and as new raw sheetside files are received. In like manner, as each completed, RIPped sheetside is transferred to a corresponding printhead, other operating parameters and status of the plurality of processors may be updated by element 506. The dashed line coupling element 506 to element 502 represents the retrieval of current operating status information by operation element 502 when computing the mathematical model to select an MRCT processor for the current raw sheetside.

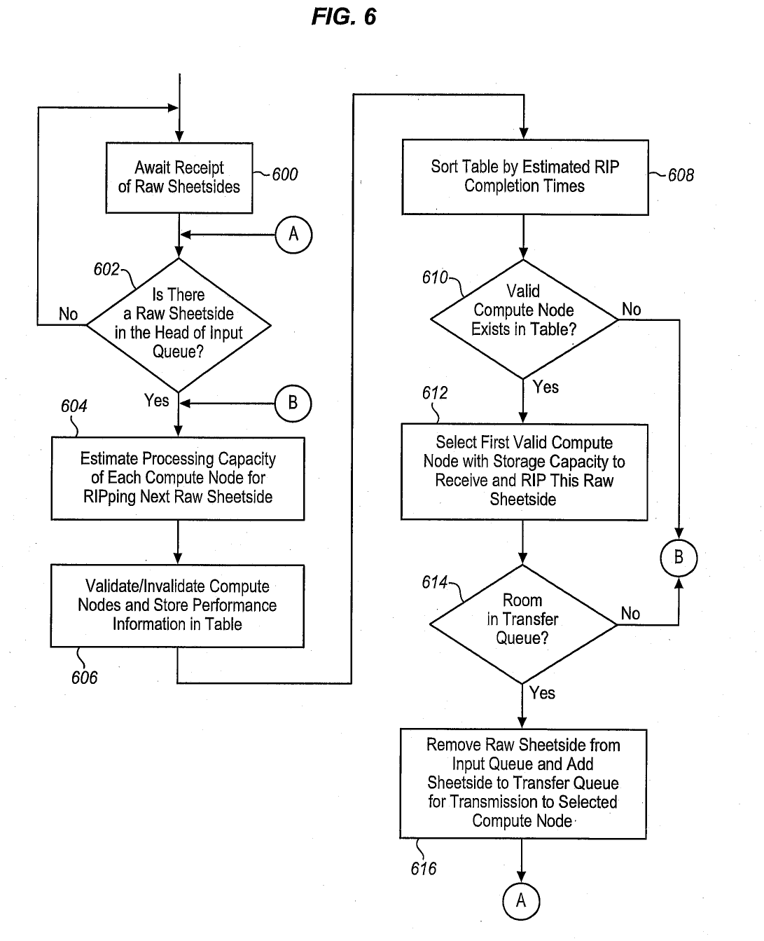

FIG. 6 is a flowchart providing additional exemplary details of a method in accordance with features and aspects hereof to improve dispatching of raw sheetsides in a print controller system having a plurality of processors (compute nodes). The method of FIG. 6 may be performed within a controlling node or a processor such as the head node discussed above. In general, the method of FIG. 6 utilizes the mathematical model described above to generate performance information regarding each of the multiple processors available for ripping the received raw sheetside data. Each received raw sheetside file is distributed to a selected compute node or processor by evaluating various performance measures discussed above as aspects of the mathematical model. Most importantly, the mathematical model is applied to determine the estimated RIP completion time for each processor of the multiple processors for each received raw sheetside. For each received raw sheetside, that compute node or processor which has storage capacity to receive the received raw sheetside and has the minimum RIP completion time (MRCT) for completing rasterization of that raw sheetside will receive the next raw sheetside. Also as noted above, a transfer queue may be used to couple the head node to the plurality of compute nodes. The transfer queue may have a limited capacity measured in a predetermined number of raw sheetsides. Thus, the head node will complete the selection method for a next raw sheetside only when the limited space of the transfer queue allows the raw sheetside to be transferred to a selected compute node. If the transfer queue has insufficient capacity to forward the raw sheetside to a selected compute node, the evaluation will be repeated later, using then current performance information to select an MRCT compute node for the next raw sheetside. Thus the selection process is deferred to the latest possible time to allow updating of the performance information and thereby improved selection of the best choice based on most current performance information of all of the plurality of processors or compute nodes.

Element 600 of FIG. 6 is first operable to receive one or more raw sheetsides from the raw datastream parser. Each sheetside comprises a collection of data in an encoded form such as a page description language (e.g., HP PCL, Adobe Postscript, IBM IPDS, etc.) or a display list. Each raw sheetside comprises a sequence of such encoded data to represent a single sheet independent of all other sheets. The independence of each raw sheetside allows the head node to distribute sheetside processing among the plurality of compute node processors. Received raw sheetsides may be stored in a spool or input queue associated with the head node until such time as the head node is ready to process them. The received raw sheetsides will be processed in order of their receipt from the attached servers/host systems.

Element 602 is next operable to determine whether there are raw sheetsides in the spool or queue associated with the head node. If not, processing returns to element 600 to await receipt of additional raw sheetsides to be processed. If there is a raw sheetside in the spool or input queue for the head node, element 604 is then operable to estimate the processing capacity of each compute node of the plurality of compute nodes for ripping the spooled raw sheetside at the front of the queue. The performance information used in determining the processing capacity of each node may include a variety of parameters such as: storage capacity of the compute node/processor to receive the raw sheetside file, an estimated RIP completion time to complete ripping of this raw sheetside (including estimated RIP times of all earlier sheetsides already queued within each compute node processor and not yet RIPped). Those of ordinary skill in the art will recognize a wide variety of other factors and parameters that may be useful in determining the processing capacity of each node.

Element 606 is then operable to determine from the performance information generated by element 604 whether each compute node is valid or invalid with respect to processing of this raw sheetside. If the performance information for a compute node processor indicates that it is incapable of processing the current raw sheetside for any of various reasons, a compute node will be invalidated. The performance information for each compute node (including the “valid” or “invalid” status) is stored in a table structure generated within the head node. The table is constructed with performance information for each of the multiple, clustered compute node processors of the printer controller regarding their respective capacity to RIP this next raw sheetside.

Processing continues at element 608 to sort the generated table from earliest to latest estimated RIP completion time for this raw sheetside. Element 610 then verifies that at least one valid compute node exists in the table. Element 612 then uses the generated table, sorted by element 608, to select the first compute node indicating that it is valid and has sufficient storage capacity to receive and RIP this raw sheetside. Since the table is sorted in order of lowest estimated RIP completion time, the first valid entry having sufficient storage capacity to receive this raw sheetside will represent the compute node having the minimum RIP completion time for this sheetside given the current performance information for all processors. If no compute node is presently capable of processing this raw sheetside, processing continues at elements 604 (label “B”) to continue evaluating performance information for each compute node until this raw sheetside is successfully processed by the SSD and placed in the transfer queue, where it will be dispatched to a selected compute node by another computational process. The dispatch method exemplified by FIG. 6 does not wait for the sheetside to be actually transmitted to the selected compute node. That processing may proceed in parallel with the dispatch method of FIG. 6 continuing to evaluate sheetsides in the input queue for possible dispatch to a compute node.

The evaluation of performance information by elements 604 and 606 is therefore dynamic in that the current performance information is re-evaluated until such time as the SSD successfully places this raw sheetside in the transfer queue for dispatch to a selected compute node processor representing the minimum RIP completion time for this raw sheetside in the current state of operation of the system.

If the element 614 determines that some valid compute node representing the current minimum RIP completion time for this raw sheetside and indicating sufficient storage capacity to receive this raw sheetside was selected by operation of element 612, element 614 is next operable to verify that there is room in the transfer queue of the head node to permit forwarding of this raw sheetside from the head node to the selected compute node's input queue. As noted above, the transfer queue may preferably have a limited capacity measured in a pre-determined number of raw sheetside files. This pre-determined threshold limit assures that the head node will only make a valid selection of the MRCT compute node at the last possible opportunity so as to assure that the most current performance information is used in the selection process. If no room is presently available in the transfer queue, processing continues at element 604 (label “B”) to continue evaluating performance information of each compute node until this raw sheetside is successfully dispatched from the head node to a selected compute node processor.

If element 614 determines that the transfer queue has sufficient capacity to allow transfer of this raw sheetside, element 616 is then operable to remove the raw sheetside from the head node input queue or spool and place the sheetside in the transfer queue for dispatch to the selected compute node. (through the head node's transfer queue mechanism). Processing then continues looping back to element 602 (label “A”) to process further raw sheetsides utilizing current performance information regarding each of the plurality of compute node processors in the print controller.

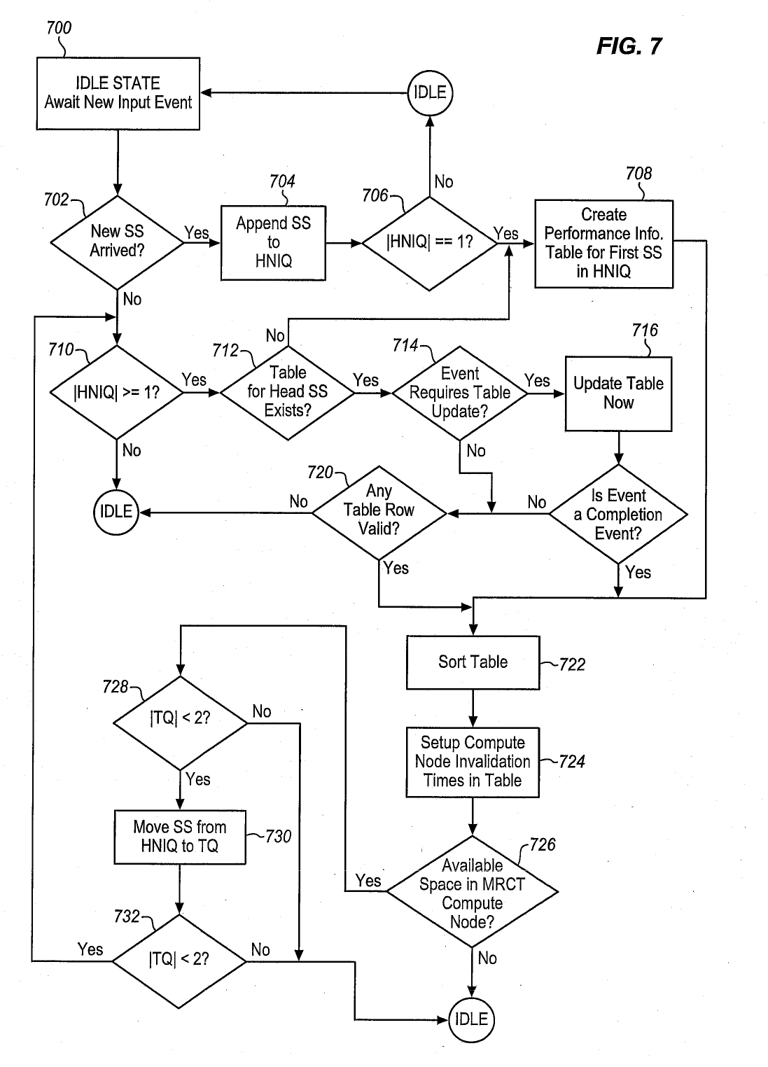

FIG. 7 is a flowchart describing another exemplary embodiment of a method in accordance with features and aspects hereof. The flowchart of FIG. 7 is analogous to a state machine diagram wherein the head node is described as in an idle state awaiting an input event to cause it to process information. After completion of all processing for that event, the state machine returns to an “idle” state to await a next input event Element 700 of FIG. 7 (label “IDLE”) represents the idle state of the “state machine”. In general, input events that cause a transition out of the idle state are: arrival of a new raw sheetside from the datastream parser, change of status of the compute nodes/processors (such as completion of RIPping of a sheetside or completion of sheetside bitmap transfer to a printhead), or the time at which feedback was expected regarding a completed bitmap on a compute node (the invalidation time) has passed. In general, any event that may give rise to a change in the performance information of the system for one or more of the compute nodes and/or arrival of a new sheetside for evaluation and dispatch will cause the state machine of FIG. 7 to exit the idle state (700) and attempt to dispatch the next sheetside in the input queue.

Upon detection of any new input event, the idle state (700) is exited and processing commences at element 702 to determine the type of event and to appropriately process the event. Element 702 determines whether the event was receipt of a new raw sheetside from the datastream parser. If so, this new raw sheetside is added at the tail of the head node's input queue (HNIQ) by element 704. If the queue was not empty before as determined by element 706, i.e., after the insertion the size of the head queue (|HNIQ|>1), then no further actions will be taken and the system returns to idle state at element 700. Otherwise, at element 708, the sheetside will be immediately considered for mapping in that the compute node lookup table will be created to determine the MRCT compute node. Three conditions must hold for a mapping or dispatch to a compute node to be made for a given sheetside: (a) the selected compute node j is the MRCT compute node for the sheetside, (b) the input buffer of compute node j has enough room to hold the sheetside, and (c) the transfer queue at the head node has space sufficient to accept the sheetside. If all the conditions are satisfied, the considered sheetside will be mapped or dispatched to its MRCT compute node, placed in the transfer queue, and the SSD returns to its idle state. If any of the required conditions does not hold, the SSD returns to its idle state, and a mapping for this sheetside is postponed.

In particular, element 722 sorts the just created/updated table with performance information for each compute node/processor to process this first raw sheetside in the head node input queue. The table is sorted in order of estimated RIP completion time for this raw sheetside for each of the compute nodes/processors. Element 724 then adds the compute node invalidation times to each table entry. As regards the invalidation time of a compute node for a particular sheetside, assume that the current wall-clock time matches INVTⱼ scheduled for compute node j. In this case, compute node j's status will be changed to invalid, the compute node lookup table will be resorted, and the compute node invalidation times will be recalculated. The MRCT compute node's entry is then located based on the sorted order of the valid candidate compute nodes/processors in the table. Element 726 then determines if the MRCT compute node's table entry indicates sufficient storage capacity to receive the new raw sheetside. If not, the system returns to idle (element 700) to await another change of status to dispatch this new raw sheetside. If element 726 determines that the sheetside's MRCT compute node has sufficient capacity to receive the raw sheetside, element 728 is operable to determine whether the transfer queue of the head node has sufficient space to hold another raw sheetside file.

As noted above, the transfer queue is preferably limited to a pre-determined fixed number of sheetsides—in a preferred embodiment, two sheetsides. This limit helps assure that the head node defers all dispatch/mapping decisions for any sheetside to the latest possible time to utilize the most current estimates of compute node/processor performance information.

If element 728 determines that the transfer queue has insufficient capacity, the system returns to idle (element 700) to defer dispatch of this sheetside. If element 728 determines that the transfer queue has sufficient capacity to store this sheetside, element 730 moves the new sheetside from the head node's input queue to the transfer queue. Element 732 then determines if yet another sheetside may fit in the transfer queue. If so, processing continues at element 710 as discussed below. Otherwise, the system returns to the idle state (element 700) to await another state change causing the head node to re-evaluate sheetside dispatch.

The system may also come out of the idle state (element 700) when a compute node completes RIPping of a dispatched sheetside or when other status messages indicate another completion within the system (e.g., completion of a transfer of a RIPped bitmap to the printhead, etc.). Element 702 will determine that the idle state was exited due to some reason other than a new sheetside arrival. Element 710 then verifies that there is at least one raw sheetside presently queued in the head node input queue. If not, the system simply returns to the idle state (element 700). Otherwise, elements 712 through 720 update the performance information lookup table for the next queued raw sheetside (or create a new table at element 708 if needed).

More specifically, element 712 determines if a table already exists for the next queued sheetside in the head node. If not, element 708 (et seq.) as discussed above creates a new table, sorts it, and uses it to locate a compute node to which this sheetside may be dispatched. If element 712 determines that the table already exists, elements 714 through 718 are operable to update that table, if needed, to reflect current performance information regarding the compute nodes/processors of the cluster controller. Some previously invalid processors may become valid and vice versa. Following creation or update of the table, elements 722 through 732 are operable as above to attempt to dispatch the sheetside to its MRCT compute node/processor.

For example, when a bitmap RIP complete notification comes from compute node j, the compute node lookup table for the sheetside will be updated for the corresponding row (e.g., element 716). If the RIP complete notification was sent from a compute node whose entry in the lookup table is invalid, then after updating the sheetside's completion time on this compute node the compute node will be marked, as valid again and the other table fields updated as needed. This includes recalculation of t_{comp}^{j}[HNᵢ], EEFTⱼ, and AC_{inf}. It is important to note that because computation of t_{comp}^{j}[HNᵢ] is recursive, the estimated RIP completion times for all the sheetsides assigned to compute node j but not RIPped yet must be updated. The invalidation times are recalculated across the entire table after new compute node ranks are determined. Further SSD actions will depend on whether the required conditions hold to map a currently considered sheetside or not.

Or, for example, consider a transfer complete input generated by the head node transmitter. This input indicates that an additional slot became available in the TQ. As a result, the mapping for the currently considered sheetside will be finalized if this was the only unsatisfied condition blocking the mapping before. No table updates are invoked with this input. In addition, the table for this sheetside will be deleted as this sheetside has now been assigned.

Paper Offset Extension

As mentioned above, sheetsides are printed on both sides of the paper by two separate marking engines separated by some distance measured in sheets of paper. This implies that certain fixed amount of time (referred to as a paper offset time) is required to pull the paper from one printhead to another to achieve proper alignment between consecutive odd and even numbered sheetsides. For purposes of simplification, the discussions above presumed this offset to be zero. The reality of a non-zero paper offset modifies the systems and methods above in only minor ways easily observed and understood by those of ordinary skill in the art. The non-zero paper offset results in two implications in the features and aspects discussed herein above:

1. The start time of the printhead 0 (e.g. 112 of FIG. 1) responsible for printing even numbered sheetsides (t₀) is equal to the start time of the printhead 1 (110 of FIG. 1) (t₁) responsible for printing odd numbered sheetsides plus the paper offset time.

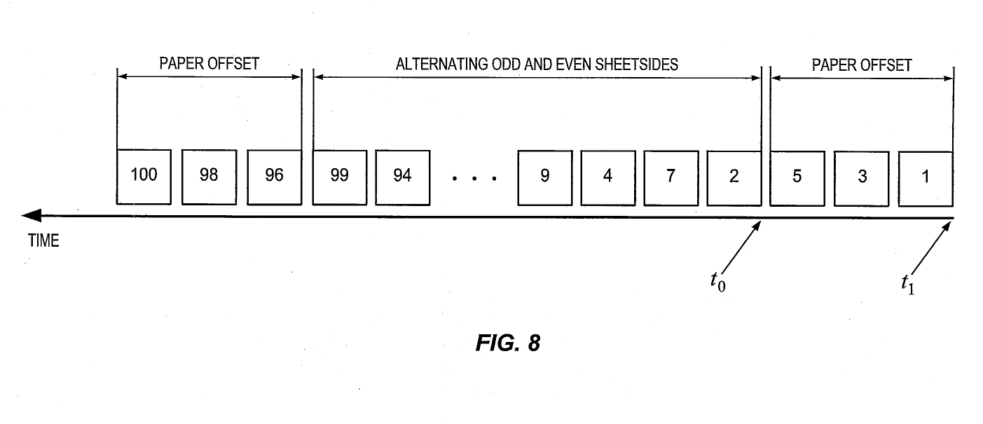

2. Sheet sides have to be rearranged in the head node input queue, because sheetside mapping order matches the order in which generated bitmaps are fetched by the printheads. Such a reordering is illustrated in FIG. 8, assuming the paper offset of 3 odd numbered sheetsides and the total number of 100 sheetsides in the print job.

Color Extensions

The compute nodes/processors used in a color printer application of features and aspects hereof are structurally identical to that used in the monochrome printer. However, the color version will have to send bitmaps to a larger population of printheads, and multiple bitmaps will be created for each sheetside. Odd and even numbered bitmaps are stored in a single output buffer of the compute node and transferred to the printheads in a FIFO fashion. It is preferable that the four bitmaps corresponding to the four color planes are created by the same compute node out of a single sheetside description file (at the same time) in the color printer application of features and aspects hereof.

Color Extension—Print Groups

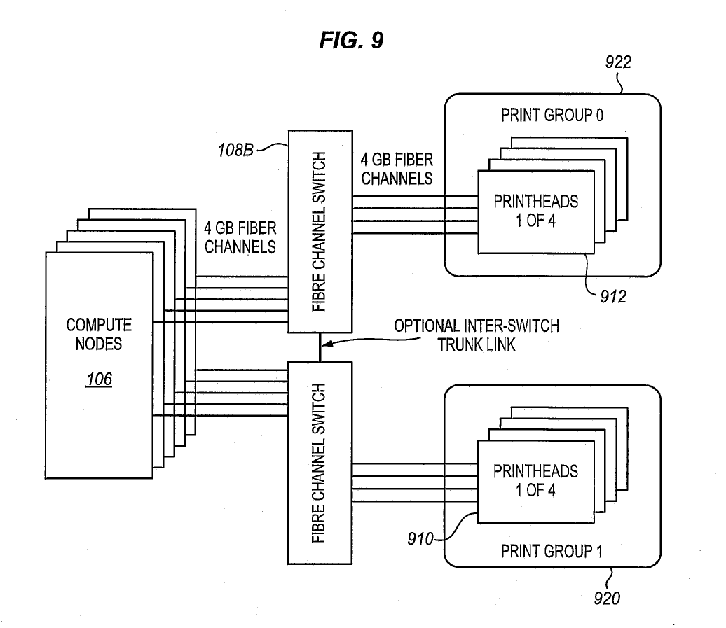

As shown in FIG. 9, there are two print groups 920 and 922 in the color printer design, each composed of four printheads 910 (1-4) and 912 (1-4). Each printhead is identical to those used in the monochrome version. The four bitmaps of a single sheetside are printed sequentially as the paper is propagated across the printheads in each print group. The time required to move the paper from one color-plane printhead to the next (referred to as the paper shift time) is a function of the printing process speed and the distance between printheads. A typical number that is presumed herein for discussion purposes is 0.12 sec. The paper shift time is a configurable parameter of the system but remains constant during operation of the system. Thus, the entire Print Group processes sheetsides in a pipeline fashion, where the pipeline stage has a length of tₚᵣᵢₙₜ and the pipeline phase is equal to the paper shift time.

Color Extension—Communication Networks

A 1 Gb Ethernet network with 50% payload efficiency may used between the head node (not shown in FIG. 9) and the compute nodes 106, identical to that used in the monochrome printer. In contrast to the single optical network connecting the blades 106 and the two printheads (110 and 112 of FIG. 1) in the monochrome version, there are two optical networks (switches 108A and 108B—4 GB effective bandwidth each) used in the color printer. The networks are designed to transfer odd and even bitmaps independently, i.e., there is no need to interleave data traffic under normal operational conditions. However, if for some reason there is a need to do that then it can be achieved by activating a high-bandwidth trunk link between the switches.

Ignoring the optional trunk link between the switches, each switch is assumed to function as a C×H non-blocking crossbar switch where C is related to the number of compute nodes and H is related to the number of printheads. Thus, multiple compute nodes 106 can communicate with unique printheads 910 (1-4) or 912 (1-4) simultaneously.

The multicast option is assumed to be enabled on the switches. This allows a switch to make four copies of a control message that is sent when a bitmap is created notifying every printhead in the corresponding print group (920 and 922). Another possible approach is to forward four control messages originating from the compute node. However, this will result in slightly higher load on the network between the compute nodes 106 and a switch 108A or 108B.

Color Extensions—Communication Conflict Resolution Scheme

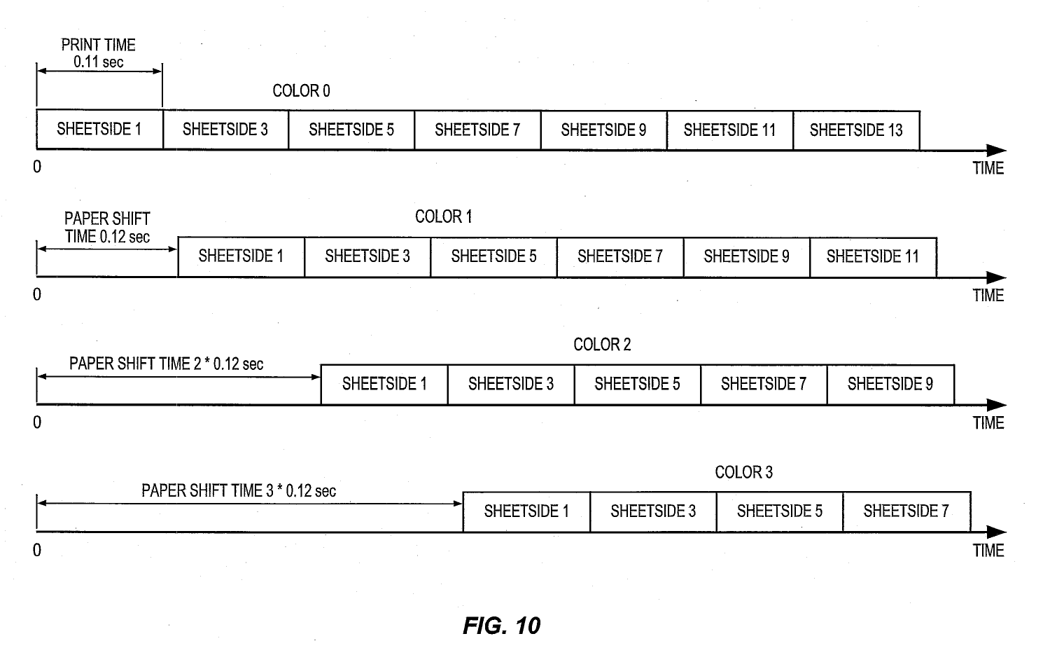

Due to the fact that four bitmaps are generated from a single sheetside description file in the color printer, the network traffic between the compute nodes 106 and printheads (910 1-4, and 912 1-4) becomes four times more intensive than that in the monochrome printer. As a result, there may occur a situation when a bitmap cannot be delivered on time to its destination printhead because the compute node's needed outgoing communication channel is busy transmitting another bitmap to the same print group (920 or 922). To provide insight into such a situation and a method for resolving the problem, consider the example depicted in FIG. 10.

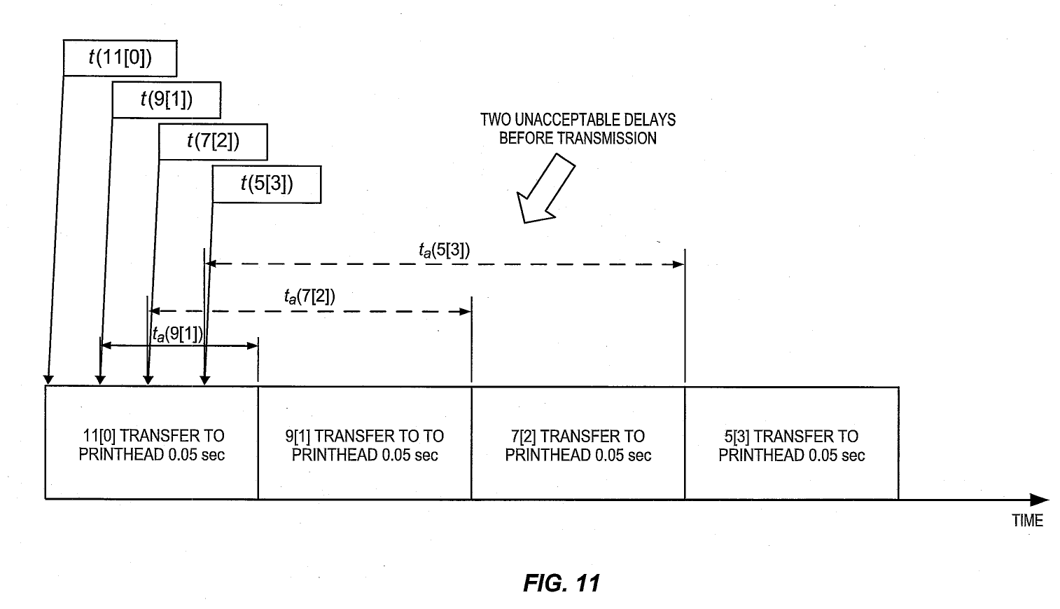

Illustrated in the timing diagram of FIG. 10 is a print group pipeline processing odd numbered bitmaps. The print times of sheetsides 5 for color 3, 7 for color 2, 9 for color 1, and 11 for color 0 overlap in time. Suppose that the bitmap for color 0 of sheetside 11 is requested from the compute node at time t(11[0]), as shown in time diagram in FIG. 11. Then the bitmap for color 1 of sheetside 9 will be requested 0.01 seconds later (the paper shift time of 0.12 sec. minus the print time of 0.11 sec.), i.e., t(9[1])=t(11[0])+0.01. Similarly, t(7[2])=t(9[1])+0.01, and t(5[3])=t(7[2])+0.01.

Assume now that all color plane bitmaps for sheetsides 5, 7, 9, and 11 are stored in the same compute node's output buffer, due to the fact that their sheetside description files were assigned for rasterization to the same compute node. Let tₜᵣₐₙ^{bitmap} be the time required to transfer a bitmap from a compute node output buffer to a printhead input buffer. For the sake of simplicity, assume tₜᵣₐₙ^{bitmap}=0.05 sec., and cut-through routing mode is activated on the fiber switch 108A and B. Recall, that when the printhead interface card's memory is full, the next bitmap is requested from the compute node at the time when the printhead completes printing one of the stored bitmaps. The time required to deliver a bitmap to the corresponding color printhead since the request was received at the compute node, t_{deliver} can be computed for each of the aforementioned bitmaps as the delay time until the communication channel becomes available, tₐ, plus tₜᵣₐₙ^{bitmap}. Specifically, for bitmap 11[0], tₐ(11[0])=0. As demonstrated in FIG. 11, tₐ(9[1]) is the time from when 9[1] is requested (i.e., t(11[0])+0.01) until 11[0] finishes using the communication channel (t(11[0])+tₜᵣₐₙ^{bitmap}) i.e., tₐ(9[1])=tₜᵣₐₙ^{bitmap}−0.01 sec. For bitmaps 7[2] and 5[3], tₐ can be calculated in an analogous manner. Then, the t_{deliver} times are:

t_{deliver}(11[0])=tₜᵣₐₙ^{bitmap}=0.05 sec;

t_{deliver}(9[1])=tₜᵣₐₙ^{bitmap}−0.01+tₜᵣₐₙ^{bitmap}=2×tₜᵣₐₙ^{bitmap}−0.01=0.09 sec;

t_{deliver}(7[2])=2×tₜᵣₐₙ^{bitmap}−2×0.01+tₜᵣₐₙ^{bitmap}=3×tₜᵣₐₙ^{bitmap}−2×0.01=0.13 sec;

t_{deliver}(5[3])=3×tₜᵣₐₙ^{bitmap}−3×0.01+tₜᵣₐₙ^{bitmap}=4×tₜᵣₐₙ^{bitmap}−3×0.01=0.17 sec.

This set of equations must be adjusted if a different forwarding mode is used on the switches.

In the considered system, if a given bitmap's t_{deliver} is greater than tₚᵣᵢₙₜ (recall, tₚᵣᵢₙₜ is 0.11 for this example) then it will not be delivered by the time it is needed for printing. According to this rule, sheetsides 7 and 5 will not be delivered on time in the example discussed. If the SSD does not consider compute nodes that have already been assigned two sheetsides whose print times overlap with the considered sheetside, then this unacceptable situation will be avoided. Those skilled in the art will be able to adjust this set of equations to various communication environments and derive a “banned” sequence of sheetsides assignments to the same compute node.

In the described example, it was assumed that requested bitmaps are transmitted to printheads sequentially—this allows us to determine that bitmaps 11 [0] and 9[1] will be delivered in time as opposed to bitmaps 7[2] and 5[3]. In practice, many production network protocols force concurrent data transfers over the same communication channel. Nevertheless, the provided analysis and the derived restriction on the SSD's assignment process hold for that case as well or else some sheetsides will not be delivered by the time they are needed. The only difference is that which bitmaps fail to be delivered in time depends on the details of the protocol used.

Bitmap Compression Extensions

Features and aspects hereof can readily be extended so that bitmap compression can be applied to reduce the file size of the generated bitmaps. Bitmap compression has the following benefits for the intended system:
1. More bitmaps can be stored in the output buffer of each compute node, which implies that more bitmaps can be generated in advance on the compute nodes. This can improve performance by having a larger number of bitmaps stored when later bitmaps take a long time for generation.
2. Alternatively, compression may be used to reduce system memory requirements by allowing the required number of bitmaps to be generated and stored in less memory space.
3. Network traffic between the compute nodes and printheads is reduced. This implies faster bitmap deliveries and might result in a less restrictive communication conflict resolution scheme (see the Communication Conflict Resolution Scheme section for details).
4. Alternatively, compression can reduce the network bandwidth requirements by reducing the number of bits that must be transferred to the printheads during printing.

The obvious drawback of bitmap compression is in the extra CPU work required to generate the compressed version of a bitmap. This extra CPU work will delay the creation of a bitmap, which is an equivalent of having the longer estimated RIP execution time for sheetsides.

To extend features and aspects hereof to include bitmap compression, examples of the aspects that should be taken into account are as follows. Because the result of a compression attempt is not known a priori, sufficient space must be reserved to accommodate the entire uncompressed bitmap when a CPU retrieves a sheetside for RIPping. Also, a control message has to be sent to the head node specifying the actual file size of the completed compressed bitmap.

Although specific embodiments were described herein, the scope of the invention is not limited to those specific embodiments. The scope of the invention is defined by the following claims and any equivalents thereof.

We claim:

1. A method for distributing sheetside processing in a cluster computing printer controller, the method comprising:
receiving a print job comprising multiple sheetsides; and
for each sheetside, performing the steps of:
determining an estimated RIP completion time for said each sheetside for each processor of multiple processors in the printer controller; and
dispatching said each sheetside to a selected processor of the multiple processors having the minimum RIP completion time for said each sheetside.

2. The method of claim 1
wherein each of the multiple processors has an input queue adapted to receive sheetsides previously dispatched to the processor to be RIPped,
wherein each of the multiple processors dequeues a next sheetside to be processed from its input queue, and
wherein the step of dispatching further comprises:
storing the sheetside in the input queue of the selected processor.

3. The method of claim 2
wherein the step of determining further comprises:
determining the estimated RIP completion time based on the estimated RIP completion time for all sheetsides presently residing in the input queue of said each processor.

4. The method of claim 1
wherein the step of dispatching further comprises:
transferring said each sheetside to the selected processor through a transfer queue common to all of the multiple processors wherein the transfer queue has a predetermined limited capacity of sheetsides, and
wherein the steps of determining and dispatching are deferred while the transfer queue is full.

5. The method of claim 1
wherein the step of determining further comprises:
determining an invalidation time for said each sheetside for said each processor as a function of the estimated RIP completion time of said each sheetside for said each processor, and
wherein the step of dispatching further comprises:
dispatching said each sheetside to a selected processor of the multiple processors, the selected processor having the minimum RIP completion time for said each sheetside and such that the current time does not exceed the invalidation time for said each sheetside for the selected processor.

6. The method of claim 1 further comprising:
receiving feedback from said each processor indicating completion of processing of any sheetside dispatched thereto,
wherein the step of determining further comprises:
determining an earliest expected feedback time for said each processor as the earliest time feedback is expected from said each processor; and
determining an invalidation time for said each sheetside for said each processor as a function of the estimated RIP completion time of said each sheetside and as a function of the earliest expected feedback time for said each processor, and
wherein the step of dispatching further comprises:
dispatching said each sheetside to a selected processor of the multiple processors, the selected processor having the minimum RIP completion time for said each sheetside and such that the current time does not exceed the invalidation time for said each sheetside for the selected processor.

7. The method of claim 1
wherein the steps performed for each sheetside further comprises:
invalidating any processor of the multiple processors that is presently incapable of processing said each sheet side within a predetermined maximum time, and
wherein the step of dispatching further comprises:
dispatching said each sheetside to a selected valid processor of the multiple processors having the minimum RIP completion time for said each sheetside.

8. A method for processing sheetsides in a cluster computing printer controller having multiple processors coupled to a head node processor, the method comprising:
receiving, at the head node, raw sheetside data to be RIPped to generate a corresponding plurality of RIPped sheetside images;
for each raw sheetside performing the steps of:
determining performance information that estimates the current processing capacity of said each processor for RIPping said each raw sheetside to generate a RIPped sheetside;
selecting a processor of the multiple processors based on the performance information; and
dispatching said each raw sheetside to the selected processor.

9. The method of claim 8
wherein the step of determining further comprises:
determining that a processor of the multiple processors is processing sheetsides slower than the estimated performance information for the processor indicates; and
identifying the processor as invalid for dispatch of a next sheetside in response to the determination that the processor is processing slower than expected, and
wherein the step of selecting further comprises:
selecting a valid processor of the multiple processors based on the performance information.

10. The method of claim 8
wherein the step of determining further comprises:
determining an invalidation time for the next sheetside for each processor of the multiple processors; and
identifying a processor as invalid if the current time exceeds the invalidation time without detecting the next expected event, and
wherein the step of selecting further comprises:
selecting a valid processor of the multiple processors based on the performance information.

11. The method of claim 8
wherein performance information indicates whether said each processor is operating as estimated, and
wherein the step of selecting a processor further comprises:
indicating that said each processor is invalid if the performance information indicates that said each processor is not operating as estimated; and
selecting a processor from among the multiple processors that are not indicated as invalid for processing of said each raw sheetside.

12. The method of claim 8
wherein the step of dispatching further comprises:
queuing said each raw sheetside in a transfer queue for transmission to the selected processor, the transfer queue adapted to store no more than a predetermined fixed maximum number of raw sheetsides,
wherein the step of determining performance information further comprises:
awaiting capacity in the transfer queue for said each raw sheetside prior to selecting a processor; and
updating the performance information while awaiting capacity in the transfer queue.

13. The method of claim 12
wherein the step of updating further comprises:
updating the performance information while awaiting capacity in the transfer queue in response to detection of events.

14. The method of claim 8
wherein each sheetside is a multi-color sheetside having multiple color bitmap planes when RIPped,
wherein each processor is coupled to multiple printheads each corresponding to a color bitmap plane,
wherein the step of determining further comprises:
determining communication timing for said each color bitmap plane of said each sheetside for said each processor; and
identifying as invalid any processor for which the communication timing may conflict with communication timing determined for others of said color bitmap planes of any sheetside.

15. A system comprising:
a head node adapted to receive data representing a plurality of raw sheetsides to be RIPped to generate a corresponding plurality of RIPped sheetsides;
a plurality of processors communicatively coupled to the head node, each processor adapted to process a raw sheetside to generate a corresponding RIPped sheetside; and
a plurality of printhead interfaces for receiving a RIPped sheetside for marking on an image marking engine,
wherein each of the plurality of printheads is controllably coupled to any of the plurality of processors to receive a RIPped sheetside,
wherein the head node is adapted to dispatch a raw sheetside to a selected processor of the plurality of processors, and
wherein the head node is adapted to select the selected processor by estimating the RIP completion time for said raw sheetside for each of the plurality of processors and then selecting the selected processor as the processor having the minimum RIP completion time.

16. The system of claim 15 further comprising:
a transfer queue switchably coupling the head node to each of the plurality of processors for transferring a raw sheetside to the selected processor wherein the transfer queue has a pre-determined fixed capacity of raw sheetsides.

17. The system of claim 16
wherein the head node is adapted to await available capacity in the transfer queue for a next raw sheetside before selecting a processor for said next raw sheetside, and
wherein the head node is adapted to update estimates of RIP completion time for said next raw sheetside for each of the plurality of processors while awaiting available capacity in the transfer queue.

18. The system of claim 17
wherein each of the plurality of processors is coupled to the transfer queue through an input queue having a pre-determined fixed capacity to store raw sheetside information received from the head node through the transfer queue,
wherein the head node is adapted to await available capacity in the input queue of at least one of the plurality of processors to receive said next raw sheetside before selecting a processor for said next raw sheetside, and
wherein the head node is adapted to update estimates of RIP completion time for said next raw sheetside for each of the plurality of processors while awaiting available capacity in the input queue of at least one of the plurality of processors.
